(19) United States
(12) Patent Application Publication
(10) Pub. No.: US 2025/0269948 A1
(43) Pub. Date: Aug. 28, 2025

(54) THRUST SYSTEM FOR STEERING MARINE VESSELS

(71) Applicant: LIQUID PROPULSION, LLC, Salt Lake City, UT (US)

(72) Inventors: Robert Christensen, Salt Lake City, UT (US); Martin Johnson, Draper, UT (US); Eric Nofsinger, North Salt Lake, UT (US); Kaulin Curtis, Taylorsville, UT (US)

(21) Appl. No.: 19/066,125

(22) Filed: Feb. 27, 2025

Related U.S. Application Data
(60) Provisional application No. 63/559,054, filed on Feb. 28, 2024.

(51) Int. Cl. B63H 21/17; B63H 21/21

(52) U.S. Cl. CPC B63H 21/17; B63H 21/21; B63B 2209/00

(57) ABSTRACT

A thruster system for improved steering and maneuverability of a marine vessel when operating at relatively low, or wakeless speeds, such as in the vicinity of docks, swimmers or other obstacles, or when trailering, beaching or mooring. The thruster system has a modularized design adapted to independently control separate motor/driver units located at various positions on the vessel's hull. Each driver (e.g., propeller or impeller) of the modular thruster motor system has its own relatively small, electric motor and mounting bracket, permitting each motor to be separately mounted to a location on the hull of the marine vessel apart from other thruster motors. The thruster system is further enhanced by an electrical control system for controlling each modular thruster motor system of the thruster system. In some embodiments, a charging system is provided that permits each electrical control system to be separately charged from the marine vessel's main battery.

### CROSS REFERENCE TO RELATED APPLICATION

This Application claims the benefit of U.S. Provisional Application No. 63/559,054,filed Feb. 28, 2024, which is incorporated by reference in its entirety.

### FIELD OF THE INVENTION

Embodiments of the present invention relate to devices, systems and methods for thrust systems used for maneuvering marine vessels. In particular, the present invention relates to a thrust system having modularized devices and systems adapted to independently control separate motor/propeller units located at one or more positions on the vessel's hull in order to improve the way thrust may be applied to the hull of a marine vessel in order to maneuver the vessel at low speeds, for example, in wake-free zones or shallow areas, when maneuvering around swimmers or other obstacles, or when docking or trailering.

### BACKGROUND

Marine vessels, such as ships, boats, barges, personal watercraft, and the like, are widely used for a variety of purposes, such as for travel, fishing, shipping, and recreational uses. In use, marine vessels often encounter situations and areas where travel at low speeds is necessary and/or required. For example, in wake-free zones or shallow areas, low, wakeless speeds are required when maneuvering around swimmers or other obstacles and when docking or trailering.

Typically, marine vessels maneuver at low speeds by operating the main propulsion and steering system, i.e., engine(s), propeller(s) and rudder(s) at low speeds. In these situations, the thrust produced by the main engine and propeller, in combination with the steering feature of the rudder and/or propeller, are relied on to steer or maneuver the marine vessel. At slow speeds, the propeller is not always spinning, and turning the rudder of the marine vessel may produce little or no turning effect. This lack of control increases the possibility that the watercraft may collide with obstacles, resulting in property damage and/or increased risk of personal injury to swimmers or other watercraft users. This is particularly true in the case of watercrafts with primary propulsion systems comprising one or more fixed propulsion shaft(s) turning one or more propellers and having one or more moveable rudders in proximity to the one or more propellers to steer the boat. In short, steering of marine vessels (such as pleasure craft, e.g., boats or yachts used for water skiing, wake boarding or the like, and personal watercraft) at low speeds suffers from diminished directional control when relying on the craft's main engine, propeller, and rudder system.

Thruster systems have been developed to increase maneuverability of marine vessels when they must travel at lower speeds and/or in areas with limited space (see Miller et al. U.S. Pat. No. 10,331,137). Such thruster systems typically consist of a smaller motor-driven propeller system that operate independently of the vessel's main propulsion system (e.g., engine and propeller). Such thruster systems eliminate the need to manipulate a powerful main engine to cause the marine vessel to maneuver the vessel at low speeds. This provides for more precise control and positioning of the marine vessel at low or wakeless speeds.

However, such thruster systems are often configured to draw power directly from the

main battery of the marine vessel and/or the alternator of the engine of the marine vessel.

Although small, the modular thrusters in the thruster system require short but significant bursts of power in order to provide sufficient thrust to maneuver a marine vessel. In addition to the thruster system, the main battery of a marine vessel can act as a power source for a plurality of accessories including a stereo system, light installations, and bilge pumps. Because the main battery is under constant strain, drawing short, significant bursts of power from the main battery and/or the alternator can threaten to overload the main battery.

Accordingly, there remains a need for improved thruster systems that provide enhanced maneuverability of marine vehicles at slow speeds that can address the foregoing problems.

### BRIEF SUMMARY

The exemplary embodiments as illustrated and described herein relate to a thruster system for improved steering and maneuverability of a marine vessel when operating at relatively low, e.g. wakeless, speeds, such as in the vicinity of docks, swimmers or other obstacles, or when trailering, beaching, or mooring. In general, example embodiments of the thruster system are designed in such a way as to allow for directing thrust applied to the vessel's hull at multiple locations and in differing thrust directions depending on each location at which the thrust is applied. The thrust directions can be determined in such a way as to allow for the craft to be precisely maneuvered and positioned, automatically and/or manually. The described embodiments of the thruster system allow the operator of the marine vessel to effectively move the craft in directions that are not easily achieved, and often impossible, using the main propulsion/steering system (i.e., motor, propeller, and rudder).

Thruster systems described herein can have a modularized design adapted to independently control separate thruster motor/propeller units located at various positions on the vessel's hull in order to improve the way thrust may be applied to the hull of a marine vessel in order to more precisely maneuver the vessel in different ways at low speeds to address a variety of situations that may require unique or specialized maneuvers. Also, as compared to the main boat propeller, which is oriented to propel the marine vehicle in forward and reverse directions essentially parallel to the longitudinal axis of the boat, while being able to turn to steer the boat left or right, the thruster system propellers can be substantially perpendicular to (e.g., within ±25°, ±20°, ±15°, ±10°, ±7.5°, ±5°, or ±2.5° of perpendicular) relative to the longitudinal axis of the boat. In some embodiments, the thruster system propellers are in a fixed (non-turnable), substantially perpendicular position relative to the hull of the marine vessel. In other cases, they can be transverse, yet fixed, relative to the longitudinal axis (See FIG. 14)

In addition, each “driver unit” (e.g., propeller or impeller) of the modular thruster system can have its own relatively small electric motor, battery pack, and mounting bracket. This permits each thruster motor/driver unit to be separately mounted at location on the hull of the marine vessel apart from the other thruster unit(s). This allows separate thruster motor/driver units to be mounted, for example, at opposite sides of the rear end of a boat, as well as at other strategic locations along the hull to provide thrust at those locations. Strategically locating the thruster motor/driver units in this way helps to increase the thrust provided by each separate driver unit and thus permits each motor to be much smaller in size. It also permits each separate motor and driver unit to be easily and less expensively replaced in comparison to centrally mounted self-contained units. It also reduces or minimizes interference and clutter with the main propulsion/steering system.

This modular approach to thruster motor/driver unit design is further enhanced by an electrical control system for controlling each thruster motor/driver unit. The electrical control system can be provided in a single module that permits easy and cost-effective replacement when necessary, or which can be provided in separate modules that correspond to each thruster motor/driver unit. A control mechanism electrically coupled to the single or separate modules of the electrical system is used to provide operational commands used by the electrical control system to independently control the speed and rotational direction of each motor/driver unit, and thus the magnitude of thrust applied by each separate thruster motor/driver unit.

The control mechanism includes a user interface for controlling the thruster system,

which can be provided in various locations depending on design and circumstances. For example, the user interface can be integrated with the throttle, which is typically operated with one hand, and/or the steering wheel, which is typically operated with the other hand while operating the throttle with the one hand (or both hands when not operating the throttle).

Alternatively, the user interface can be separate from the throttle and steering wheel, such as in the form of a joystick, touchpad, or control buttons. For example, integration with the throttle and/or steering wheel may be advantageous when manufacturing a boat. A separate user interface may be advantageous for after-market upgrading of an existing boat to add a thruster system.

In some embodiments, a charging system is provided that permits the electrical control system, namely the dedicated battery pack, for each thruster unit to be separately charged from the marine vessel's main electrical system (i.e., main battery and/or alternator). During use of the thruster system, each thruster unit is powered by a dedicated battery pack, which helps reduce or eliminate the drain on the vessel's main electrical system when the vessel is being used.

One or more (e.g., two) thruster motor/driver units can be positioned at the stern of the marine vessel, such as one thruster unit on either side of the main motor/propeller of the marine vessel. In some embodiments, one or more thruster units (e.g., two) can be mounted near and/or integrated with the mounting bracket of a swim deck or other feature mounted at the stern of the vessel. This permits inclusion of thruster units without adding new features that jut out from or further clutter the stern of the boat. In other words, mounting the thruster motor/driver unit(s) near and/or integrating them with the mounting bracket of a swim deck or other existing feature reduces or eliminates clutter. The thruster motor/driver units can be advantageously mounted so as to reduce or eliminate inhibition of water movement by other features such as the rudder, swim deck bracket, or wake adjustment trim tabs.

The control mechanism may include software with pre-programmed instructions for causing the thruster system to perform specified tasks, such as automatically turning or maneuvering the boat in specific ways, such as moving the boat toward and/or holding it against a dock. This greatly simplifies docking, particularly by a single person who may need to do so without assistance.

These and other objects and features of the present invention will become more fully apparent from the following description and appended claims or may be learned by the practice of the invention as set forth hereinafter.

### BRIEF DESCRIPTION OF THE DRAWINGS

A more particular description of embodiments of the invention will be rendered by reference to the appended drawings. These drawings depict only typical embodiments or features of the invention and are not therefore to be considered to be limiting of its scope. Following is a brief description of the drawings:

FIG. 1 is a perspective view of the rear of a marine vessel that illustrates a pair of modular thruster motor/driver units mounted at the left and right sides at the stern of the vessel, showing one way of implementing modular stern thruster units;

FIG. 2 is a close-up perspective view based on FIG. 1 that illustrates in greater detail a modular thruster motor/driver unit mounted on the right side of the hull of the marine vessel;

FIGS. 3A and 3B are schematic views that illustrate example locations for mounting modular thruster motor/driver units at the stern of a marine vessel;

FIGS. 4A-4C is a schematic view that illustrate another example of locations for mounting the modular thruster motor/driver units on a marine vessel;

FIGS. 5A and 5B are schematic views that illustrate another example of mounting locations for the modular thruster motor/driver units on a marine vessel wherein the modular thruster units are deployable and retractable;

FIG. 6 is a top plan view that illustrates example mounting locations for modular thruster motor/driver units on a pontoon-style boat;

FIG. 7 is a schematic view that illustrates an electrical control system used to control the individual thruster motors, wherein the electrical control system is a single module;

FIG. 8 is a schematic view that illustrates another embodiment of an electrical control system used to control the individual thruster motors, wherein the electrical control system is configured as a single module;

FIG. 9 is a schematic view that illustrates another embodiment of an electrical control system used to control the individual thruster motors, wherein the electrical control system is configured with separate modules controlling the thrust applied by each thruster motor/driver unit;

FIG. 10 is a schematic view that illustrates another embodiment of an electrical control system used to control the individual thruster motors, wherein the separate modules of the of the electrical control system each include a battery pack;

FIG. 11 is a schematic view that illustrates another embodiment of an electrical control system used to control the individual thruster motors, wherein the separate modules of the electrical control system each include a charge controller used to limit current from the marine vessel's main battery;

FIG. 12 is a diagrammatic example that illustrates operational commands that an operator of the marine vessel can employ for maneuvering the marine vessel using one or more of the thruster motor/driver units;

FIG. 13A illustrates examples of mounting positions of thruster motor/driver units relative to the center of mass of a marine vessel;

FIG. 13B illustrates an example of the maneuvering trajectory of the thruster motor/driver units of FIG. 13A;

FIG. 14 illustrates alternative example mounting positions of the thruster motor/driver units relative to the center of mass of the marine vessel;

FIGS. 15A-15B illustrate an example embodiment of a touchpad control mechanism for inputting operational commands to the electrical control system of the thruster system; and

FIG. 15C illustrates the touchpad control mechanism of FIGS. 15A-15B positioned in a steering wheel of a marine vessel.

### DETAILED DESCRIPTION OF EXEMPLARY EMBODIMENTS

The exemplary embodiments of the thruster system and its various components and features as described herein are intended to set forth examples of ways in which the thruster system may be implemented. These examples are not exhaustive. For example, the thruster system of the present disclosure is not limited to vessels or crafts having fixed propeller shaft(s) and rudder(s). The thruster system of the present disclosure can also be applied to a personal watercraft, which may use a pump or a jet propulsion system, which can include an impeller to move water within a tube or other enclosure. The thruster system of the present disclosure can be applied to other vessels having outboard propulsion systems, inboard/outboard propulsion systems, and vessels relying on wind and sails or flowing water as primary means of propulsion.

The thruster system disclosed herein can be used on marine vessels, which can include recreational boats, such as boats used for sporting and leisure activities. These activities can include watersports such as water skiing, wakeboarding, wake surfing, sport fishing, and the like. Marine vessels can also include jet skis and other personal watercrafts. These boats may also be used for travel and other leisure activities. These boats can also include pontoon boats, and the like. These boats can range from a length of about 18 feet to about 50 feet, or about 18 feet to about 45 feet, or about 18 feet to about 36 feet. These boats may be high performance boats with limited surface space, or limited available space on the hull for mounting boat accessories.

Marine vessels, and particularly recreational boats, are expensive, so maneuvers required during docking and trailering must be precise and controlled to prevent damage to the marine vessel and also prevent injury to swimmers and/or adjacent structures. Marine vessels are often required to operate at low speeds, such as low speed zones or no-wake zones that may require speeds of no more than 10 mph, or no more than 5 mph, or no more than 3 mph. Similar speeds may be used when maneuvering around obstacles or swimmers. For docking and trailering, it may be necessary to maneuver and/or hold the marine vessel in a specific position. For example, it may be necessary to maneuver and/or hold the marine vessel against a dock for a period of time or maneuver the marine vessel onto a trailer, which can be difficult when there are waves that rock the boat out of position when moving slowly. For example, when docking in a narrow area such as a slip or a trailer, the driver of a conventional boat lacking an independent thruster system may have to use small bursts from the primary engine/propeller to propel the boat in a reverse direction, which may then be countered by a quick burst of forward propulsion to slow or halt reverse momentum, leaving the driver of the boat with reduced control over steering. In such cases, the ability of the rudder to steer the boat can be compromised or nullified.

The thruster system of the present disclosure can alleviate such difficulties by allowing a marine vessel operator to rely on one or more smaller electric motors and drivers for precise maneuvering, rather than rely on the primary propulsion/steering system. The use of automatically implemented maneuvers and/or holds can permits the boat driver to exit the boat and tie it down on a dock or trailer without assistance. This is truly revolutionary and an important advancement in the field of boating.

Other embodiments not expressly disclosed may be implemented without departing

from the spirit, scope, breadth or essential characteristics of the invention as set forth in the appended claims. Accordingly, all changes or variations of the modular thruster motor system which come within the meaning and range of equivalency of the appended claims are to be embraced within their scope.

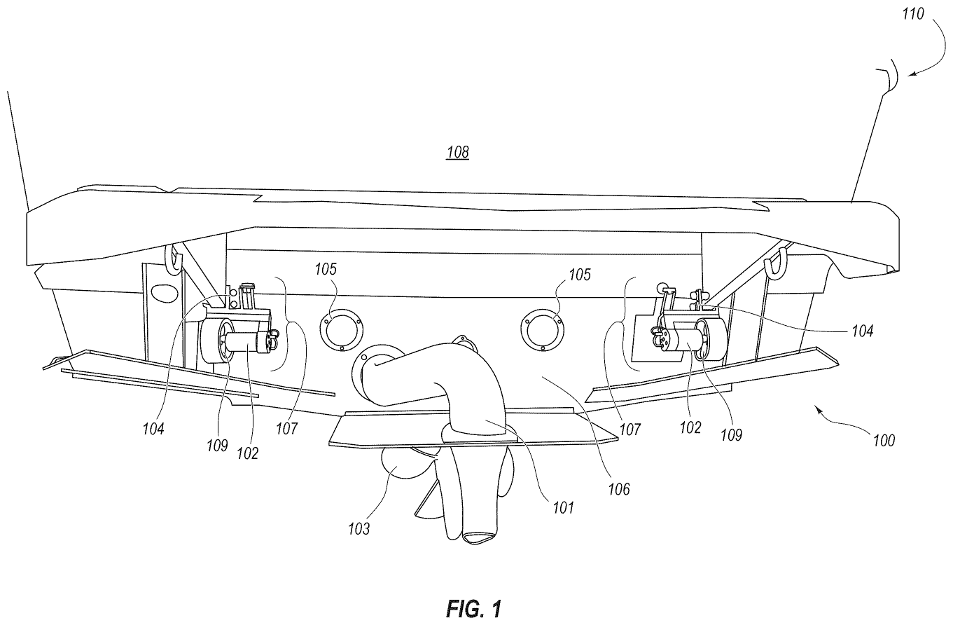

Turning now to a detailed description of the various embodiments and features illustrated in the drawings, FIG. 1 illustrates an exemplary embodiment of a thruster system 100 positioned at the stern or transom 108 of a marine vessel 110. The thruster system 100, as shown, can be modular and comprises two motor/driver units 107, which can be configured to interface with an electrical control system on board the marine vessel 110. The thruster system 100 can also include a control mechanism (user interface) (not shown) inside of the marine vessel 110, which is used by the marine vessel 110 driver or other user to actuate the electrical control system and control the modular thruster units 107.

The thruster units includes a driver unit, typically comprising a plurality of rotating blades extending from a central axis, which can be in the form of a propeller or an impeller. An impeller can be thought of a specially designed propeller that drives water through a tube, nozzle, shroud, or other enclosure, with differently shaped blades compared to conventional propellers. But the effect of rotating blades to move water in a desired direction is the same for propellers and impellers, which are generically referred to herein as “drivers”.

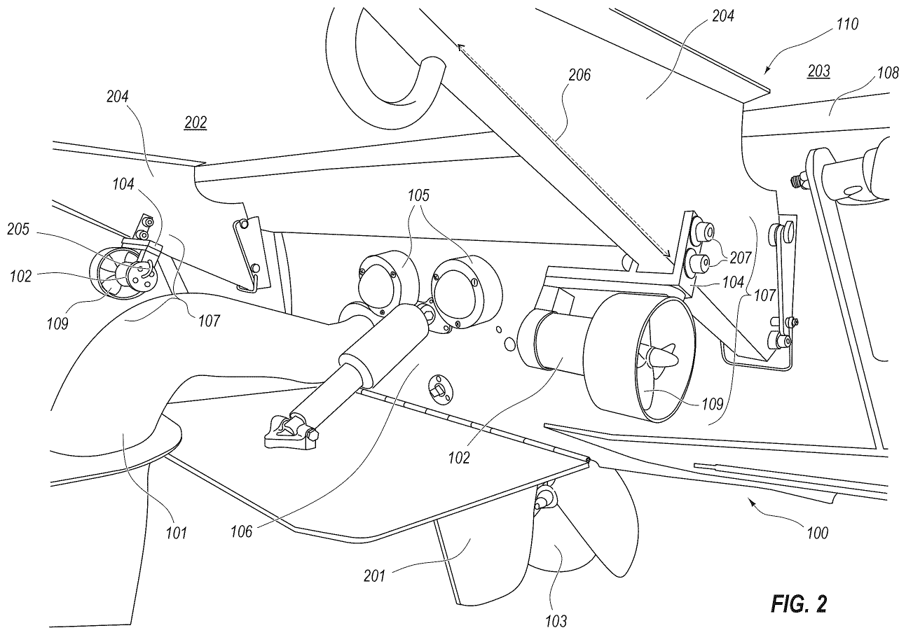

Each thruster motor/driver unit 107, as shown in FIG. 1, comprises a mounting bracket 104 adapted for attachment to the hull 106, and an electric motor 102 mounted to the bracket 104. The electric motor 102 can drive a thruster driver 109 (e.g., propeller or impeller) attached to the electric motor 102 at a desired rotational speed and direction to maneuver the marine vessel at a desired speed and direction. In some embodiments, the electric motor 102 can be a brushless electric motor. FIG. 2 provides a close-up perspective view of the exemplary view of FIG. 1.

The thruster motor/driver units 107, as shown, are mounted on the port side 202 and

starboard side 203 of the hull 106, respectively. As illustrated in FIGS. 1-2, the mounting bracket 104 to which the electric motor 102 is mounted to a support 204 extending from the hull 106. In some embodiments, the thruster units 107 can be directly mounted to the hull 106 (e.g., at the transom at the rear of the marine vessel 110).

Because the thruster motor/driver units 107 are mountable at multiple locations on the hull 106 of the marine vessel 110, this can provide a user with additional room for placement of other marine parts or accessories 105. An example of marine accessories 105 are shown in FIGS. 1 and 2 as marine lights, though other accessories typically mounted on the hull 106 may be used. Furthermore, the ability to mount the thruster motor/driver units 107 in multiple locations of the hull 106 provides for the thruster units 107 to be mounted away from the exhaust outlet 101, main propeller 103, rudder 201, and other mechanical features of the marine vessel 110.

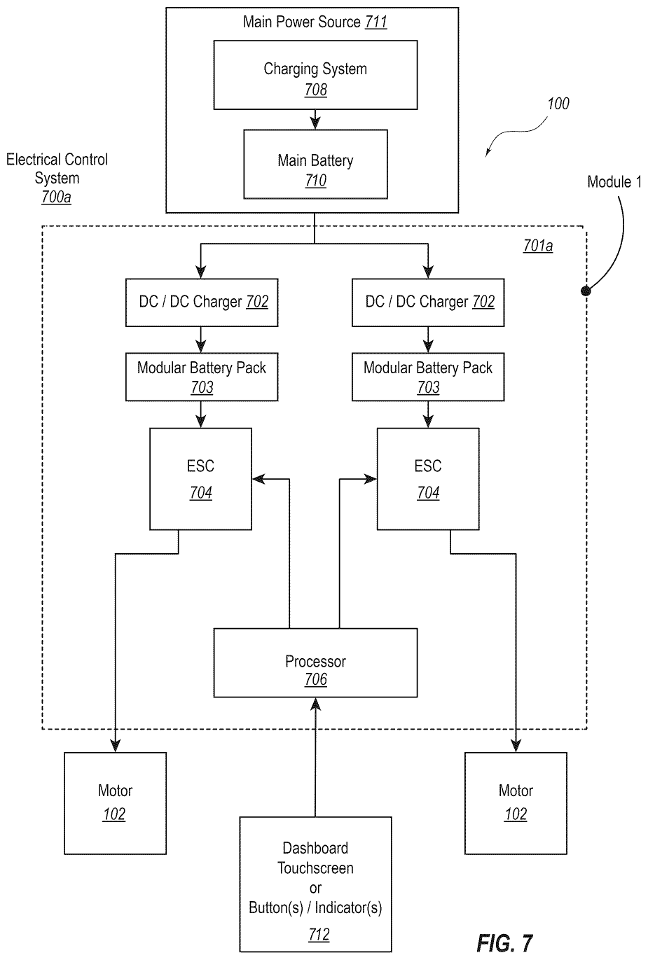

The thruster motor/driver units 107 can be modular. This modularity can allow a plurality of modular thruster units 107 to be mounted on a marine vessel 110 independent of one another. Each modular thruster motor/driver unit 107 can be independently controllable from the other modular thruster motor/driver unit(s) 107 mounted to the hull 106. Furthermore, each modular thruster motor/driver unit 107 can be independently controlled by the electrical control system 700 (see FIGS. 7-11) of or in communication with the thruster system 100 by connecting the electric motor to wiring of the electrical control system 700.

Because the modular thruster motor/driver units 107 can be independently mountable and independently controllable, they can also be independently removed from the thruster system and replaced without requiring the removal and replacement of other modular thruster units 107 of the thruster system 100. This modularity can be advantageous in the event a thruster motor/driver unit 107, or a component thereof, breaks or wears out and requires replacement.

The user need only remove the broken component from the thruster system 100 (for example, thruster motor/driver unit 107, or electrical control system 700, or separate modules of the electrical control system 700), rather than replacing the entire system.

The mounting brackets 104 disclosed herein enable a user to mount the modular thruster motor/driver units 107 at a number of different locations on (or in) the hull 106 of the marine vessel 110. The mounting brackets 104 can be attached to the hull 106 via use of attachment mechanisms known in the art, such as pins, nuts and bolts, threaded screws, and the like. The mounting bracket 104 can be mounted along a length 206 of a support 204. The support 204 can be a support for a swim deck, as shown in FIGS. 1-2, though other supports 204 or projections from the hull 106 of a marine vessel 110 may adequately support the placement of a mounting bracket 104 for mounting a modular thruster motor/driver unit 107 to the hull 106 (e.g., transom).

In some embodiments, the mounting brackets 104 provide for the motors 102 of the modular thruster motor/driver units 107 to be mounted off of the hull 106 and away from the marine vessel 110 so that the motors 102 themselves are not in direct contact with the hull 106. Rather, the mounting bracket 104 is mounted at a location on the hull 106 or on a support 204 extending from the hull 106, and the motor 102 is mounted on the mounting bracket 104. Because the motors 102 are not mounted directly on the hull 106, and are instead mounted on a mounting bracket 104, this can increase the leverage or torque exerted by the motors 102, thereby providing for relatively small motors 102 to turn a marine vessel 110 while using less power or a lower level of thrust. The electric motor 102 of the present invention may be a brushless electric motor capable of generating about 1 kw to about 3 kw of power. 1 horsepower ≅745.7 watts, and 1 kw =1000 watts, therefore the motor 102 may be capable of generating about 0.5 hp to about 4.5 hp. A small boat may have a primary trolling motor, which typically generates about 10 hp to 15 hp to propel the boat. The primary propulsion system (motor and propeller) of a water ski boat must generate at least 200 hp in order to properly drive the boat at adequate speed, while a surf boat must generate at least 500 hp or more in order to properly drive the boat at adequate speed.

Each component of the modular thruster motor/driver unit 107 can be independently removable from and separately replaceable apart from the other components of other modular thruster motor/driver unit(s) 107. For example, if an electric motor 102 requires repair or replacement, the electric motor 102 can be removed from the mounting bracket 104 and repaired, or it may be replaced with a new electric motor 102. In similar fashion, if a mounting bracket 104 were in need of repair or replacement, the mounting bracket can be removed for repair or replaced with a new mounting bracket without requiring replacement of the electric motor 102, or replacement or removal of other components of the thruster system 100, such as, for example, the electrical control system 700 or the control mechanism 712.

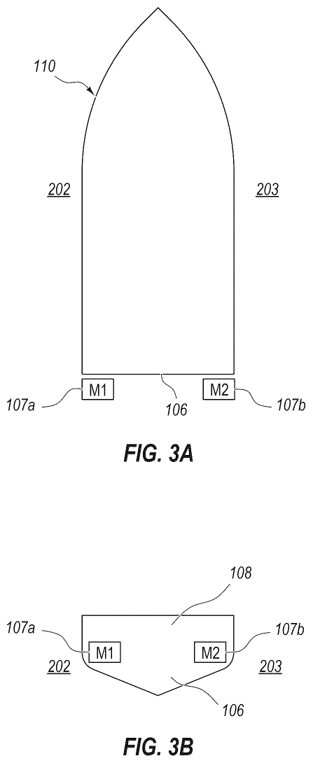

The one or more modular thruster motor/driver units 107 can be strategically mounted on the hull 106 of a marine vessel 110 to improve maneuverability. In one embodiment of a mounting configuration, as schematically illustrated in FIGS. 3A and 3B, a first modular thruster motor/driver unit 107a is mounted aft of the hull 106 on a port side 202 of a marine vessel 110, which can allow the first modular thruster motor/driver unit 107a to provide directional thrust to the hull 106 at the hull's aft on the port side. A second modular thruster motor/driver unit 107b is mounted aft of the hull 106 on a starboard side 203 of the marine vessel 110 to provide directional thrust to the starboard side 203 of the hull 106 at the hull's aft on the starboard side.

In some embodiments, such as the exemplary embodiment schematically illustrated

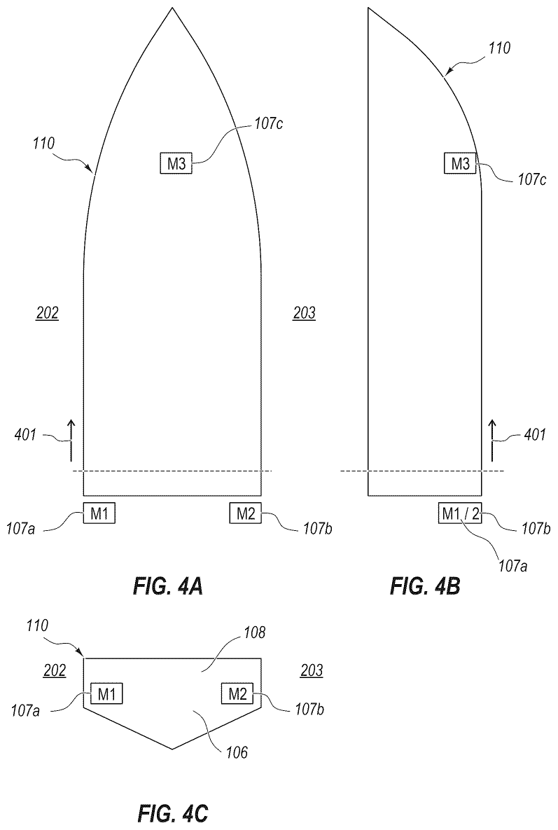

in FIGS. 4A-4C, a third modular thruster motor/driver unit 107c can be mounted on a fore portion 401 of the hull 106 of a marine vessel 110 (e.g., at or near the center as illustrated or at or near one or both sides of the hull 106 (additional thruster unit 107 not shown)). The third modular thruster motor/driver unit 107c can be mounted towards a fore portion 401 of the hull 106 relative to the aft mounting locations of the first and second modular thruster motor/driver units 107a, 107b to provide a complementary turning force at a different location than the hull's aft

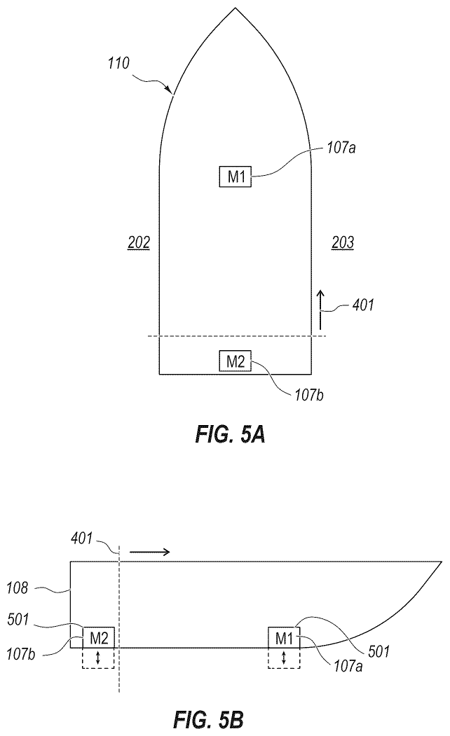

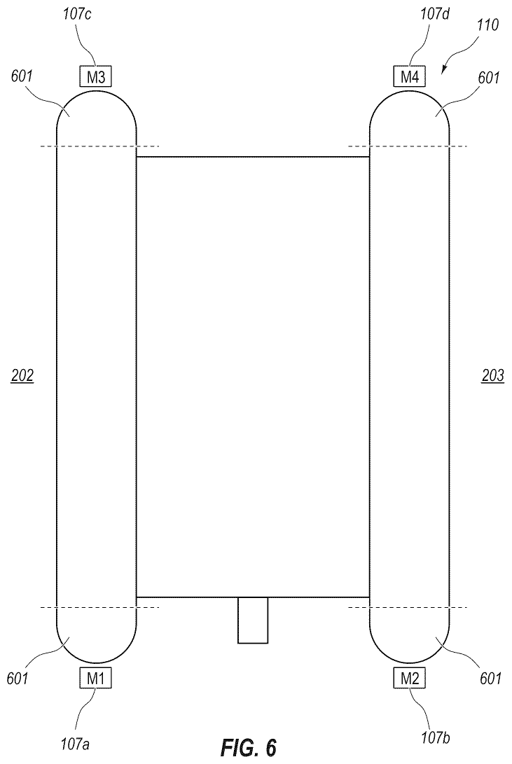

In another embodiment, schematically illustrated in FIG. 5A, the first modular thruster motor/driver unit 107a can be mounted towards a fore portion 401 of the hull 106 relative to the mounting position of the second modular thruster motor/driver unit 107b, which can be mounted aft of the hull 106 on or at the transom 108 of the marine vessel 110. On certain marine vessels, it may be advantageous to add a fourth modular thruster motor/driver unit 107d, such as on a pontoon boat (FIG. 6), or marine vessels 110 with similar configurations. On a pontoon boat, the modular thruster motor/driver units 107 can be mounted on respective aft and fore end portions 601 of the marine vessel 110.

Each of the modular thruster motor/driver units 107 can be independently mountable to and removable from their respective mounting location on the hull 106 of a marine vessel 110, with respect to other modular thruster motor/driver unit(s) 107 and other components of the thruster system 100. Furthermore, each modular thruster motor/driver unit 107 can be independently controlled and operated apart from other modular thruster units 107, as well as operated in tandem with other modular thruster units 107 of the thrust system 100. For example, a modular thruster motor/driver unit 107 mounted aft of the hull 106 on the starboard side 203 can be activated while other modular thruster units 107 mounted to the hull 106 remain inactive and/or are not included in the overall thrust system. In other example, modular thruster motor/driver unit 107b as depicted in FIGS. 5A-5B can be activated while modular thruster unit 107a mounted at the fore end of the hull 106 remains inactive and/or is not included in the overall thrust system. Conversely, in another example, a modular thruster motor/driver unit 107 mounted aft of the hull 106 on the starboard side 203, and a modular thruster unit 107 mounted aft of the hull 106 on the port side 202 can be activated and operated in tandem or in concert with one another.

In some embodiments, the modular thruster motor/driver unit(s) 107 can be in a retractable system, as illustrated in FIGS. 5A and 5B. At least one of the modular thruster motor/driver units 107 can be stored within a cavity 501 in the hull 106 of the marine vessel 110, such as when the modular thruster units 107 are not in use and/or when the primary propulsion system of the marine vessel 110 is in operation. The modular thruster motor/driver units 107 can be deployed from their respective cavities 501 by a user activating a control mechanism coupled with the electrical control system to deploy the modular thruster units 107. In some embodiments, once deployed, the motor 102 and/or the entirety of the modular thruster motor/driver unit 107 can oscillate or articulate so as to allow for independent thrust vectoring.

In some embodiments, the electrical control system 700 (FIGS. 7-11) can be configured to deploy or activate or engage the modular thruster motor/driver units 107 automatically, without user input or activation of the system, when the electrical control system detects that the marine vessel 110 is operating in a manner which meets conditions for automatic deployment. The conditions for automatic deployment of the modular thruster motor/driver units 107 may include operation of the marine vessel 110 below a designated speed threshold, operation of the marine vessel 110 in shallow water, sensing of obstacles within a certain range of the marine vessel 110, trailering, docking, etc.

Various sensors can be incorporated into the electrical control system to assist in maneuvering the boat, such as GPS, one or more proximity sensors, and sensors that permit triangulation relative to objects, such as a trailer, dock, slip, or other marine vessel.

Turning now to FIGS. 7-11, the thruster system 100 includes an electrical control system 700 for independently controlling each modular thruster motor/driver unit 107. The electrical control system 700 comprises electrical circuit components configured to independently control the electric motor 102 of each thruster motor/driver unit 107 to provide a directional thrust in order to apply force to the hull 106 of a marine vessel in a desired direction or vector, in order to, for example, provide enhanced maneuverability at low speeds.

The electrical control system 700 can be mounted inside of a marine vessel, such that the electrical control system 700 can be accessible from a deck portion of the marine vessel (not shown) and remain protected from water. The deck portion of a marine vessel can be the interior of the marine vessel, which does not come into contact with the body of water in which the marine vessel operates during ordinary use. Ordinary use does not include accidents which might expose the interior of the marine vessel to water, such as, for example, capsizing.

The electrical control system 700 can be mounted inside of the marine vessel independent of other components of the thruster system 100, such as the modular thruster motor/driver units 107 and control mechanism 712. The electrical control system 700 can also be removed from the marine vessel independent of the aforementioned thruster system components 100, thereby allowing the user to fix or replace electrical circuit components or the entire electrical control system 700 without requiring removal of the modular thruster units 107 or the control mechanism 712.

As illustrated in FIGS. 7-11, the electrical circuit components of the electrical control

system 700 can comprise various combinations of the following components including: DC/DC charger(s) 702, modular battery pack(s) 703, electronic speed control (ESC) unit(s) 704, processor 706, on/off relay 714, and charge controller(s) 716. In some embodiments, electrical circuit components may be integrated into or housed within other components of the thruster system 100. For example, the electric motor 102 may be configured to house a modular battery pack 703 and an ESC unit 704 within the housing of the electric motor 102. In some embodiments, the processor 706 may be incorporated or integrated with a control mechanism, such as a touchscreen or tablet computer.

As further illustrated by the embodiments in FIGS. 7-11, the electrical control system 700 can be comprised of a single module 701 comprising electrical circuit components, or in the alternative, the electrical control system 700 can comprise one or more modules 701, wherein each module 701 can comprise electrical circuit components.

FIG. 7 illustrates a first example embodiment of a thruster system 100, comprising a plurality of motors 102, which are each part of a modular thruster unit 107 (see FIG. 1-2) and electrical control system 700a, and a control mechanism 712. The electronic control system 700a as illustrated comprises a single module 701a comprising one or more DC/DC chargers 702, each DC/DC charger electrically coupled to a modular battery pack 703, an electronic speed control (ESC) unit 704 coupled to each modular battery pack 703, and a processor 706 electrically coupled to each ESC unit 704. The ESC unit(s) 704 can be configured so that each ESC unit 704 separately controls one of the electric motors 102.

The thruster system 100 can further comprise a charging system 708 and a main battery 710, wherein the charging system 708 is electrically coupled to a main battery 710. Charging system 708 and main battery 710 together may also be referred to as the main power source 711. The charging system 708 can be an integrated charging system of the marine vessel 110, or it can be a separate component added to the marine vessel to charge the main battery 710. Charging can be done by drawing power from the alternator of a marine vessel 110, though charging may be supplemented by solar panels, wind turbines, or other renewable energy harvesters which can be mounted on a marine vessel 110. Main power source 711 (i.e., charging system 708 and main battery 710) may be configured to provide power to various electrical components of the marine vessel 110, such as the electrical control system 700, as well as components of marine vessel 110 that are not included in the present application.

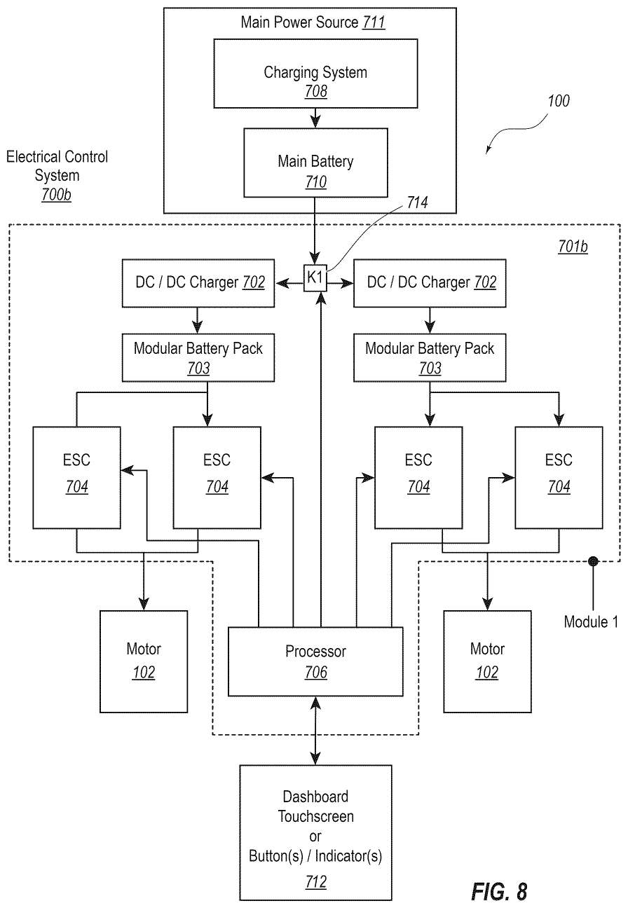

The main power source 711 can be electrically coupled to a DC/DC charger 702, wherein the DC/DC charger 702 converts an input current from the main power source 711 comprising an input voltage (e.g., 12 volts) to an output current comprising a voltage sufficient to charge a modular battery pack 703 (e.g., 54.6 volts). Therefore, the main power source can supply power to the electrical control system 700 via the DC/DC charger 702, which can in-turn supply power to each modular battery pack 703, and which can in-turn supply power to each ESC unit 704, such as to power the motors 102. In embodiments where the electrical control system 700 comprises an on/off relay 714, the on/off relay 714 (FIG. 8) can be electrically coupled to the main power source 711, thereby enabling and disabling the power flow from the charging system 708 and/or main battery 710 to the electrical control system 700.

In some embodiments, the on/off relay 714 comprises an accessory switch electrically coupled to the DC/DC charger 702 that enables power flow from the main power source 711 to electrical control system 700 within a specified input voltage range. For example, the specified input voltage range may be 11 volts to 16 volts, or 11.5 volts to 15 volts, or 12 volts to 14.5volts, or 13 volts to 14.25 volts, or 13.8 volts to 14 volts, or a range with endpoints comprising any of the foregoing voltages.

The thruster system 700 can further comprise a control mechanism 712 electrically

coupled to the electrical control system 700. The control mechanism 712 can provide operational commands used by the electrical control system 700 to control the electric motor 102 of each modular thruster unit 107, either independently or in tandem, to provide the desired amount of directional thrust to the hull 106 of a marine vessel 110. In some embodiments, the control mechanism 712 can be configured as a separate module that can be independently removable from and separately replaceable apart from any module of the electrical control system 700. The control mechanism 712 can be configured to input commands to the processor 706. The processor 706, being electrically coupled to the ESC unit 704, communicates the input commands to the ESC unit 704, thereby controlling the directional thrust applied to the hull 106 of the marine vessel 110 by the one or more electric motors 102.

FIG. 8 illustrates another embodiment of a thruster system 700, wherein the electrical control system 700b comprises one module 701b. The module 701b, as shown, comprises at least one modular battery pack 703, wherein each modular battery pack 703 is electrically coupled to respective ESC units 704 configured in pairs. Each ESC unit 704 can independently control each of the electric motors 102. In embodiments where a single ESC unit 704 is paired with a motor 102, the ESC unit 704 can be a bi-directional ESC unit, capable of causing the motor 102 to selectively spin the driver 109 (e.g., propeller or impeller) in either a clockwise and a counterclockwise direction depending on the desired direction of thrust. In some embodiments, the ESC units 704 may only be capable of spinning the motor 102 in one direction, therefore, two ESC Units 704 may be used, wherein one ESC unit 104 causes the motor 102 to spin only in a clockwise direction, and the other ESC unit 704 causes the motor 102 to spin only in a counterclockwise direction. By pairing these mono-directional ESC units 704, the motor 102 to which they are paired can cause the driver 109 to selectively spin in either a clockwise and a counterclockwise direction depending on which ESC unit 704 is activated.

The electrical control system 700b can further comprise at least one DC/DC charger 702, wherein each DC/DC 702 charger can be electrically coupled to the one or more modular battery packs 703. An on/off relay 714 can be electrically coupled to each of the DC/DC chargers 702. The on/off relay 714 can regulate the power flow from the main power source 711 to the electrical control system 700b. A processor 706 can be electrically connected to each of the ESC units 704 and to the on/off relay 714.

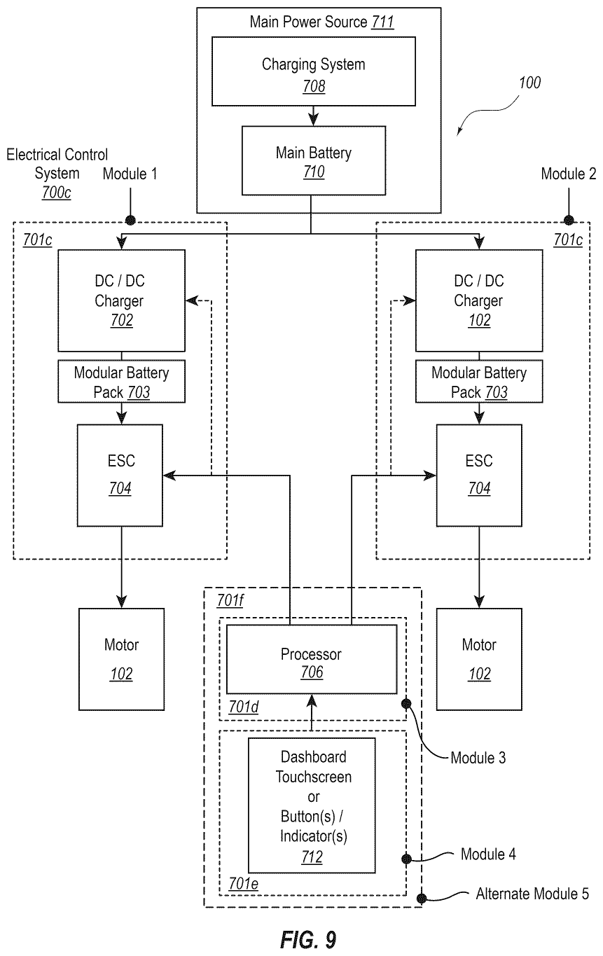

FIG. 9 illustrates another embodiment of a thruster system 100, which comprises one or more thruster motors 102, a processor 706, a control mechanism 712, and a charging system 708 coupled to a main battery 710, wherein the charging system 708 and main battery 708 comprise a main power source 711. In the embodiment of FIG. 9, each motor/driver unit 107 is controlled by its own corresponding separate module 701c. Each module 701c comprises electrical circuit components configured to provide the directional thrust that is independently controllable for each electric motor 102.

The electrical control system 700c further comprises independent modules 701d and 701e, each configured to be removed from and separately replaceable in the electrical control system 700c apart from any other module of the electrical control system 700c.

A first module 701c can comprise at least one DC/DC charger 702, a modular battery pack 703 electrically coupled to the DC/DC charger 702, and an ESC unit 704 electrically coupled to the modular battery pack 703. A second module 701c similarly comprises at least one DC/DC charger 702, a modular battery pack 703 electrically coupled to the DC/DC charger 702, and an ESC unit 704 electrically coupled to the modular battery pack 703. Each of the ESC units 704 can be electrically coupled to a separate electric motor 102.

A third module 701d can comprise a processor 706, which can be electrically coupled to each ESC unit 704 of the first module and the second module 701c. As noted, because the processor 706 comprises a separate module 701d, it can be removed from and separately replaceable in the electrical control system 700c without requiring removal or replacement of other modules.

The thruster system 100, as illustrated in FIG. 9, can include a main power source 711. The main power source 711 can be electrically coupled to first module 701c and second module 701c by coupling the main power source 711 to each DC/DC charger 702 of each respective module. The main power source 711 is discussed above in relation to FIGS. 7-8 and is discussed further below.

The thruster system 100 of FIG. 9 further includes a control mechanism 712, which can be configured as a fourth module 701e so as to be removable from and separately replaceable apart from any of modules 701c or module 701d of the electrical control system 700. The control mechanism 712 can be configured to input commands to the processor 706, and the commands can be used to control the directional thrust to be applied to the hull 106 of the marine vessel 110 using the ESC unit 704 for each electric motor 102.

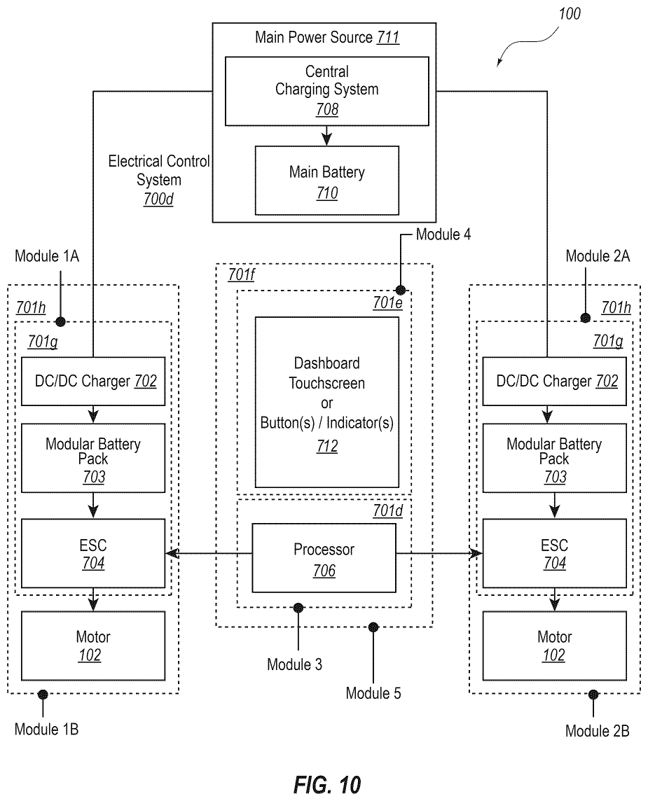

In some embodiments, the processor 706 and control mechanism 712 may be combined to form an integrated module 701f (see also FIG. 10). When configured in this way, the integrated module 701f can take the form of, for example, a boat dashboard, a tablet computer having a touchscreen, a smartphone, or similar electronic device comprising the function of both a processor 706 and a control mechanism 712. In this embodiment, a tablet computer may be used to download software programmed to control the operation of the thruster system 100. This can allow a user to download software while traveling or engaging in boating activities. Once the software has been downloaded, the tablet computer or smartphone may be electrically coupled to the modules 701c of the electrical control system 700.

In another embodiment, when the processor 706 and control mechanism 712 are combined to form an integrated module 701f, the processor 706 may still be separately removeable or replaceable apart from the control mechanism 712.

Turning now to FIG. 10, which illustrates another embodiment of a thruster system 100, the electrical control system 700d can comprise a plurality of independent modules, each configured to be removed from and separately replaceable in the electrical control system 700d apart from any other module of the electrical control system 700d. A first module 701g can comprise a DC/DC charger 702, a modular battery pack 703, and an ESC unit 704. A second module 101g can also comprise a DC/DC charger 702, a modular battery pack 703, and an ESC unit 704.

The modular battery pack 703 can receive power (i.e., be recharged) from main power source 711, wherein the modular battery pack 703 can serve as an independent power source for a corresponding ESC unit 704 once the modular battery pack 703 has been charged. Each ESC unit 704 can be electrically coupled to a separate electric motor 102 and configured to control the rotational speed and direction of the electric motor 102.

A third module 701d can comprise a processor 706, which can be removable from and separately replaceable apart from any other module of the electrical control system 700d. In an alternative embodiment, as discussed above for FIG. 9, the control mechanism 712 can be integrated with the processor 706, forming an integrated module 701f, which is removable from and separately replaceable apart from the other modules of the electrical control system 700d.

In some embodiments, the DC/DC charger 702, the modular battery pack 703, and the ESC unit 704 can be combined with the electric motor 102 to form a separate module 701h. Modules 701g can, in some embodiments, be integrated with separate electric motors 102 to form the modules 701h of the electrical control system 700d. In this embodiment, the electric motor 102 of the modular thruster motor/driver unit 107 can comprise a DC/DC charger 702, a modular battery pack 703, and an ESC unit 704. In some configurations, the DC/DC charger 702, the modular battery pack 703, and the ESC unit 704 can be removable from and separately replaceable apart from the electric motor 102 in the case where the DC/DC charger 702, the modular battery pack 703, and/or the ESC unit 704 need to be repaired or replaced.

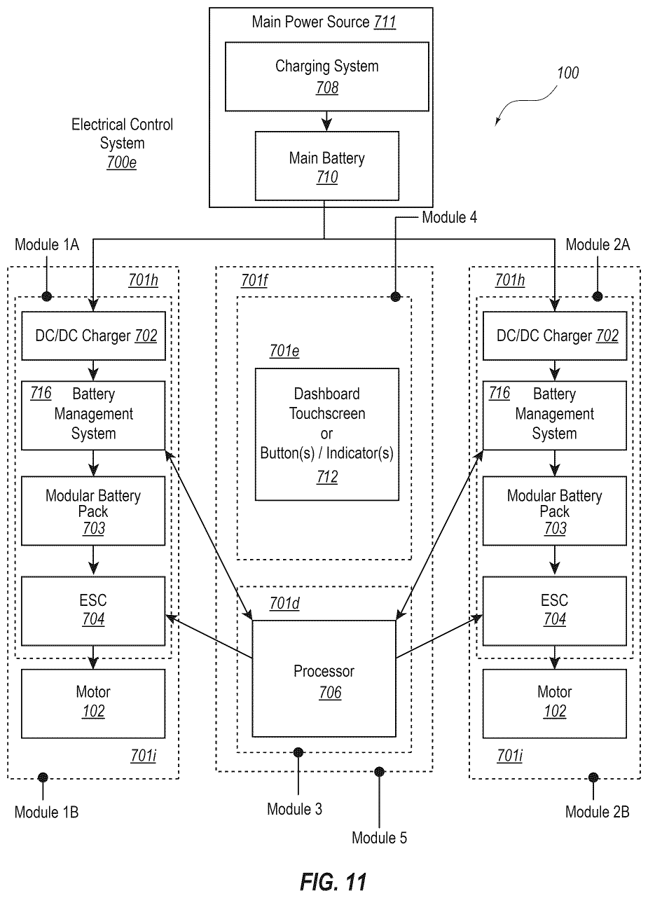

In another embodiment of a thruster system 100, the electrical control system 700e can comprise three or more independent modules 701, wherein each module 701 of the electrical control system 700e can be removable from and separately replaceable in the electrical control system apart from any other modules 701 of the electrical control system 700. FIG. 11 illustrates an embodiment similar to the electrical control system 700d of FIG. 10, but with the addition of a battery management system 716. The ability to remove or replace each module apart from other modules of the electrical control system 700 can be advantageous by allowing a user to repair or replace a module without disassembling or removing the entire electrical control system 700 or the entire thruster system 100.

The battery management system 716 illustrated in FIG. 11 can be used to moderate the charging progress of the modular battery packs 703, for example, by limiting current drawn from the main power source 711, during operation of the primary engine of the marine vessel 110. In some embodiments, the battery management system comprises software integrated into the modular battery pack 703.

The battery management system 716 (FIG. 11) can cause the modular battery packs 703 to receive an input charging current at a time-dependent charge current and charge voltage, which is calculated based on the chemistry of the battery, resulting in the modular battery pack(s) 703 becoming fully charged without overcharging and potentially damaging the modular battery pack(s) 703. The battery management system 716 can also prevent the modular battery pack(s) 703 from discharging power below a level that is suitable for the battery chemistry by imposing a minimum discharge level. Furthermore, the battery management system 716 can limit or prevent the modular battery packs 703 from discharging under environmental conditions that may result in damage to the electrical control system 700. For example, the battery management system 716 can limit or halt a discharge current of modular battery pack(s) 703 when components of the electrical control system 700 get too hot, too cold, or when the electrical control system 700 short circuits.

The electrical control system 700e of FIG. 11 can comprise a first module 701h comprising an ESC unit 704 electrically coupled to a modular battery pack, which in turn is connected to a DC/DC charger 702 and wherein battery management system 716 is provided to control the output charging current from DC/DC charger 702 that is received by modular battery 703. A second module 701h can also comprise an ESC unit 704, a modular battery pack 703, a DC/DC charger 702, and a battery management system 716. Modules 701h can be independently operable of each other and can be removable from and separately replaceable in the electrical control system 700e apart from any other modules of the electrical control system 700e.

In some embodiments, the electrical circuit components of modules 701h can be in electrical communication with or electrically coupled to separate motors 102 and configured to control each respective motor 102 independently of one another. The ESC unit 704 of each module 701h can be electrically coupled to the processor 706 and to a separate motor 102 in order to execute commands communicated to the ESC unit 704 from the processor 706.

The current required by the ESC unit 704 to operate the motor 102 typically requires between 100 amps to 150 amps at 12 volts. Minimizing the loss of power between the modular battery pack 703 and the motor 102 can result in more energy being delivered to the motor 102, which can in-turn produce more thrust. Loss can be minimized by reducing the resistance in the electrically conductive wires between the modular battery pack 703 and ESC unit 704 and the motor 102. Resistance can be reduced by reducing the length of the wires, which can require that the modular battery pack 703, the ESC unit 704 and the motor 102 be physically close to one another, or by increasing the cross-sectional areas of the wires which can add cost and weight. Resistance can also be reduced by using batteries of higher voltage than the main battery, as a higher voltage can provide the same power at reduced amperage.

In order to provide for the modular battery pack 703, ESC unit 704, and motor 102 to be close to one another to reduce resistance, the modular battery pack 703 and ESC unit 704 can be housed in a water-tight compartment within the housing of the motor 102. Module 701g and module 70li of the electrical control systems 700d and 700e of FIG. 10 and FIG. 11 respectively, illustrate the integration of a motor 102 with at least an ESC unit 704 and a modular battery pack 703. Submerging the water-tight compartment containing the modular battery pack 703 and ESC unit 704 in water with the motor 102 can provide the added benefit of allowing for liquid cooling of the modular battery pack 703 and ESC unit 704, resulting in safer operation of the electrical control system and less strain and wear on electrical components.

Generally, use of the thruster system 100 involves one or more short bursts over a small amount of time relative to the amount of time the primary engine of a marine vessel is in use during operation. The main battery 710 of a marine vessel 110 is typically charged during operation of the primary engine by a charging system 708. Due to this time/use ratio, the amount of time available for harvesting energy to charge the main battery 710, as well as the modular battery pack(s) 703, is greater relative to the time required to operate the thruster system 700.

This can provide for the use of modular battery pack(s) 703 (FIGS. 7-11) which are small relative to the main battery 710 and can be discharged relatively quickly and charged relatively slowly.

In some embodiments, the modular battery pack(s) 703 may comprise a battery chemistry that can maximize the energy density of a modular battery pack 703 while limiting the size of the modular battery pack 703. For example, some embodiments of the modular battery pack 703 comprise a lithium-ion battery, such as a lithium iron phosphate (LFP) battery, a lithium cobalt oxide (LCO) battery, and/or a lithium nickel manganese cobalt oxide (NMC) battery. By way of comparison, a typical lead-acid battery has an energy density of about 30 Wh/kg to about 50 Wh/kg, whereas a typical LFP battery has an energy density of about 90 Wh/kg to about 160 Wh/kg, a typical LCO battery has an energy density of about 150 Wh/kg to about 200 Wh/kg, and a typical NMC battery has an energy density of about 150 Wh/kg to about 220 Wh/kg. The improved power density of lithium-ion batteries compared to batteries with alterative chemistries (e.g., a lead acid battery) accords lithium-ion batteries a longer run time in relation to the battery size. In other words, modular battery pack(s) 703 comprising a lithium-ion battery can provide sufficient power output to operate thruster units 107 while occupying less space and having less weight compared to batteries with alternative chemistries.

In accordance with the power density requirements described above, batteries comprising a chemistry other than lithium-ion may be substituted into the various embodiments of modular battery pack(s) 703 as long as they accord modular battery pack 703 with a similar or improved power density.

Because individual lithium battery cells can be much smaller than lead-acid battery

cells, lithium battery packs used herein can have significantly greater voltage while taking up significantly less space and weighing substantially less than a lead-acid battery of similar voltage and capacity. In some embodiments, modular battery pack(s) 703 can have a voltage in a range of about 24 volts to about 72 volts, or about 28 volts to about 68 volts, or about 32 volts to about 64 volts, or about 36 volts to about 60 volts, or about 40 volts to about 54 volts, or a voltage within a range with endpoints comprising any of the foregoing values. By including a high voltage battery compared to the main battery 710 (i.e., about 24 volts or higher), the modular battery pack(s) 703 can be more compact than modular batteries at a lower voltage while maintaining a battery capacity sufficient to operate thruster system 100. Providing compact modular battery pack(s) 703 can alleviate space constraints imposed on the electrical control system 700, making thruster system 100 more compact and easier to install. In addition, increased voltage can provide the same power at decreased amperage, which reduces resistance through the wires compared to lower voltages.

In some embodiments, the modular battery pack(s) 703 can have a battery capacity in a range of about 10 amp hours to about 25 amp hours, or about 11 amp hours to about 22 amp hours, or about 13 amp hours to about 19 amp hours, or about 15 amp hours to about 17 amp hours, or any capacity within a range with endpoints comprising any of the foregoing values.

As described throughout the specification, the main power source 711 is configured to charge the modular battery pack(s) 703, wherein the DC/DC charger 702 is configured to upconvert an input voltage from the main power source 711 (e.g., about 12 volts) to a higher output voltage (e.g., 54.6 volts when modular battery pack 703 comprises a 48 volt battery), wherein the upconverted output voltage charges a modular battery pack 703.

The DC/DC charger 702 comprises an input terminal and an output terminal. In some embodiments, the DC/DC charger 702 comprises isolated grounds (i.e., the DC/DC charger 702 input terminal comprises a first grounding wire and the DC/DC charger 702 output terminal comprises a second grounding wire). Providing the DC/DC charger 702 with isolated grounds limits the amount of current going through a single grounding wire and reduces or eliminates surges that can damage the electrical control system 700, including overloading the grounding wire in the case of a single grounding wire.

The charge current and power received by a modular battery pack 703 from the main power source 711 is typically substantially less than the amount of current and power required by the ESC unit 704 to operate the electric motor 102. For example, if the modular battery pack has a voltage rating of 48 volts, the input charging current received by the DC/DC charger 702 from the main power source 711 can, for example, be in a range of about 10 amps to about 50 amps at 12 volts, or about 2.2 amps to about 11 amps at 54.6 volts after the DC/DC charger 702 upconverts the input charging current to an output charging current received by the modular battery pack 703, while the amount of current required by the ESC unit 704 to operate the electric motor 102 may be about 20 amps to about 37.5 amps at 48 volts (i.e., about 80 amps to about 150 amps at 12 volts). For example, a modular battery pack 703 may charge and discharge energy as follows:

Charging a modular battery pack (trickle charging):
54.6V at 4.4 A for 25 minutes
54.6V*4.4 A*1500 seconds=360,000 Ws=360 kJ

Discharging a modular battery pack (motor operating):
48V at 25 A for 5 minutes
48V*25 A*300 seconds=360,000 Ws=360 kJ

Moderate energy draw from a main power source to operate one thruster unit when used with a modular battery:
12V at 20 A for 25 minutes
12V*20 A*1500 seconds=360,000 Ws=360 kJ

Spiked energy draw from a main power source to operate one thruster unit without a modular battery pack:
12V at 100 A for 5 minutes
12V*100 A*300 seconds=360,000 Ws=360 kJ

As illustrated by the exemplary calculations presented above, operating one or more

thrusters units 107 that are coupled directly to the charging system 708 and/or the main battery 710 would cause large spikes in energy to be drawn off the main power system 711, which can threaten to discharge the main battery 710 to dangerously low levels and/or strain the electrical circuit components of an electrical control module 700. By providing modular battery packs(s) 703 as an independent power source for each ESC unit 704, wherein the main power source 711 is configured to trickle charge each modular battery pack 703 rather than being the sole power source during bursts of high power consumption by the thruster units, the power required to operate each modular thruster 107 is indirectly drawn from the charging system 708 and/or the main battery 710 over an extended period of time (i.e., trickle charging modular battery packs 703) rather than in concentrated bursts that could discharge the main battery 710 to dangerously low levels, thereby reducing the load placed on the main power source 711 to a sustainable level.

In some embodiments, the modular battery packs 703 are configured to receive an input charging current from the DC/DC charger 702 and deliver an output current to the ESC unit 704 at the same time. Furthermore, because the input charge current is substantially lower than the operational current, the wire connecting the modular battery pack 703 and the ESC unit 704 to the main power source 711 can be a smaller gauge wire, and charging can take place by trickle charging.

Trickle charging can be advantageous for a number of additional reasons, including reduction in overall cost of manufacturing by allowing for the use of smaller gauge (or smaller diameter) wires that are less expensive. Larger gauge or larger diameter wires typically comprise copper, which is an expensive material. Trickle charging can also result in a reduction in the overall weight of the thruster system 100 due to the use of smaller diameter wires, as well as a reduction in power dissipation (i.e. heat) in the wire, resulting in a safer and more efficient charging system.

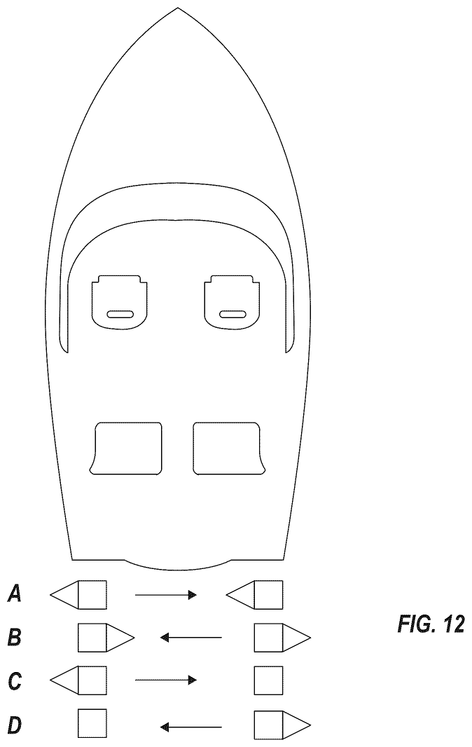

Turning now to FIG. 12, the control mechanism 712 of the thruster system 100 allows a user to input commands to the processor 706, which then cause the electrical control system 700 to control the modular thruster motor/driver units 107 to perform a variety of functions. The command inputs to the processor 706 from the control mechanism 712 may be a number of pre-programmed commands, while in other embodiments the commands may be entered manually, or the control mechanism 712 can be configured with both pre-programmed commands and a manual command entry function. The manual command entry function may include commands that enable a user to activate a specific directional thrust for each motor 102 independent of other motors 102, where the combination of directional thrust commands applied to each motor 102 can cause the marine vessel to maneuver in a specific direction or manner. For example, a user may enter a combination of commands to initiate a dock-hold sequence, wherein the motor/driver units 107 can work individually and/or in combination to maintain the position of a boat against a dock so that the user can perform other tasks, such as tying off the boat to the dock, or picking up passengers, possibly without outside assistance.

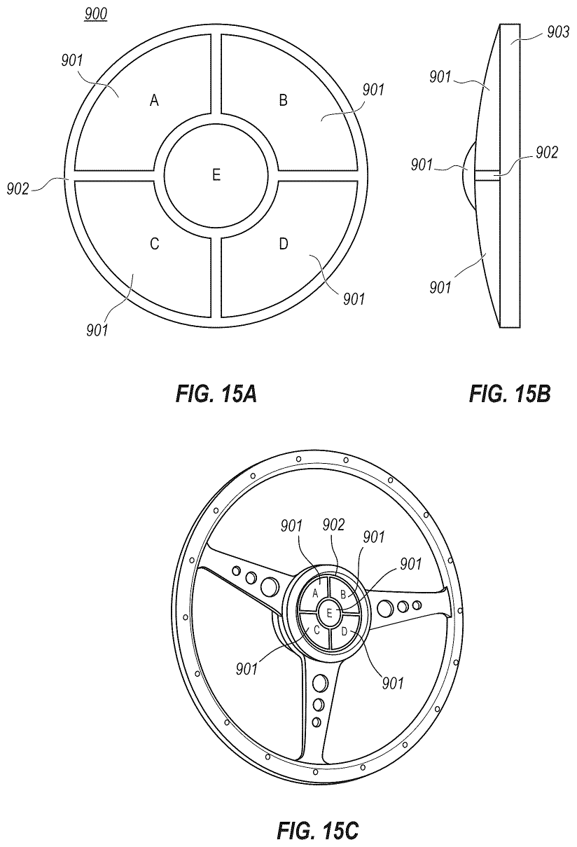

When the commands are pre-programmed, a user may activate the control mechanism 712 by, for example, pressing a button 901 (FIGS. 15A-15C), which can activate a pre-programmed response. The pre-programmed thrust mode can comprise, for example, A) a starboard burst caused by simultaneous activation of a port side motor in forward, and a starboard motor in reverse. Additional thrust modes can include: B) a port burst caused by simultaneous activation of a port side motor in reverse and a starboard motor in forward, C) a starboard dock-hold caused by simultaneous activation of the port side motor in forward and the starboard motor in neutral, and D) a port side dock-hold caused by simultaneous activation of the port side motor in neutral and the starboard side motor in forward. The dock hold function can be set to operate for a desired time period, such as from 30 seconds to 5 minutes once the pre-programmed dock-hold feature is initiated.

In summary, the electrical control system and/or control mechanism can be adapted to cause the thruster units move or urge the marine vessel in a predetermined manner. The electrical control system may include executable instructions that, when executed by the electrical control system, cause the thruster units to move or urge the boat in the predetermined manner. In addition or alternatively, the control mechanism can be adapted so that, upon receipt of one or more user-initiated commands, the electrical control system causes the thruster units to move or urge the boat in the predetermined manner, such as a dock-hold sequence.

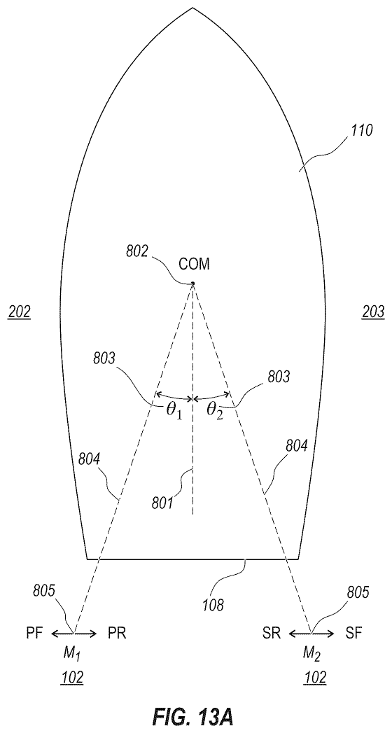

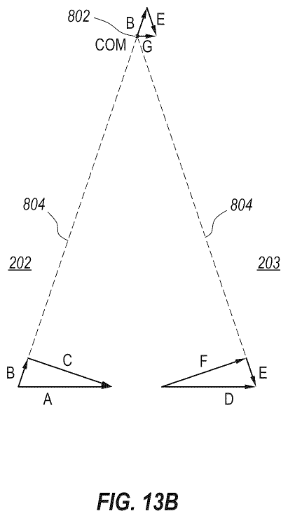

The mounting location of the modular thruster motor/driver units 107 can affect the type of maneuverability available to a marine vessel 110 when performing rotational movements or lateral movements such as dock-holds. As shown in FIGS. 13A-13B, modular thruster motor/driver units can be mounted at a variety of angles (θ₁, θ₂) relative to a line 801 that runs from the center of mass 802 perpendicular to the transom 108 (the main, longitudinal, or central axis) to produce a wide variety of maneuvering effects. FIG. 13A illustrates the mounting position of modular thruster motors 102 of thruster units 107 as shown in FIGS. 1 and 2, where the motors 102 of motor/driver units 107 illustrated elsewhere are positioned to produce thrust along vector line 805 parallel to the transom 108 (i.e., substantially perpendicular to the main, longitudinal, or central axis). As shown in FIG. 13A by vector lines 805, motors 102 of thruster units 107 can be controlled to provide directional thrust as follows: Port Forward (PF), Port Reverse (PR), Starboard Forward (SF), Starboard Reverse (SR). Various combinations of these directional thrust functions can cause the hull 106 of the marine vessel to maneuver accordingly as explained further below.

In this configuration, as noted, the motors 102 of modular thruster motor/driver units 107 are mounted so that the thrust vectors 805 are parallel with the transom 108 of the marine vessel 110. This mounting location can provide for the modular thruster units 107 on the port and starboard sides 202,203 of the vessel to apply directional thrust to the hull 106 to cause the marine vessel 110 to move in the respective direction of each or any combination of the thrust vector arrows A, B, C, D, E, F, and G along the constriction lines 804 as shown in FIG. 13B. This configuration in turn can force the marine vessel 110 to move laterally, and thus might be preferred when executing dock-hold functions, or other lateral maneuvers.

In FIG. 13B, for example, vector A can be decomposed into vector B and vector C. Vector C can cause the marine vessel to rotate about its center of mass 802 and vector B can move the boat forward. Vector F can work in concert with vector C to cause the marine vessel to rotate about its center of mass 802, while vector E can move the marine vessel in a reverse direction. Vector E and vector B can be added together to result in vector G. Vector G can cause the marine vessel to move to the side, while being rotated about its center of mass 802 by the combination of vector C and vector F. Vector C and vector F can cancel each other out if vector A and vector B are thrusting toward each other.

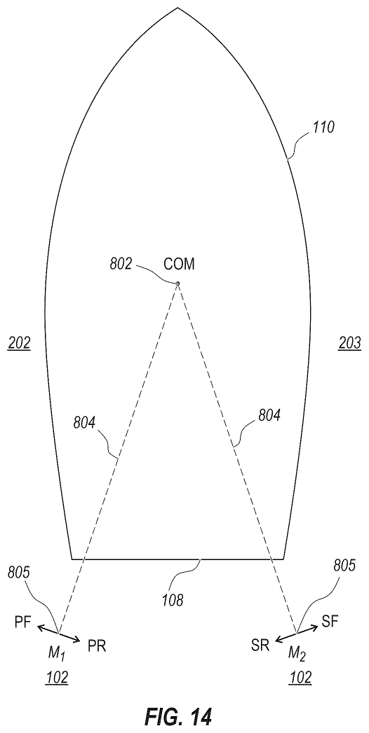

FIG. 14 illustrates an alternative mounting position of motors 102 of the modular thruster motor/driver units 107 shown elsewhere. The motors 102 are mounted such that the thrust vectors 805 of thruster units 107 are perpendicular to the line 804 from the center of mass 802 of the marine vessel 110, so as to be transverse but not perpendicular to the main or longitudinal axis of the marine vessel 110. Because the thrust vectors 805 are perpendicular to the lines 804, they do not cause the marine vessel 110 to move laterally relative to the center of mass 802 as the marine vessel 110 does in FIGS. 13A and 13B. In other words, because the placement of the motors 102 of modular motor/thruster systems 107 in FIG. 14 does not force the center of mass 802 of the marine vessel 110 to move laterally, the marine vessel 110 instead only rotates about its center of mass 802, with the net effect being that the center of mass 802 can remain substantially stationary as the marine vessel 110 rotates around its center of mass 802. This configuration may cause the center of mass 802 to travel in a circle as the marine vessel 110 rotates about its center of mass 802. Because this configuration rotates the marine vessel 110 about its center of mass 802 with minimal to no lateral movement, this configuration might be preferred for burst functions. In some embodiments, an actuator which adjusts the direction of the electric motor 102 or of the modular thruster unit 107 may be incorporated to provide for directional adjustment of the motor 102 to produce optimal maneuverability when executing lateral or rotational movements.

FIGS. 15A-15C illustrate an embodiment of control mechanisms 712, which provides user interface. The control mechanism (user interface) 712 is configured to input commands to the processor 706, wherein the input commands are used to control directional thrust to be applied to the hull 106 of a marine vessel 110 as discussed above (see FIGS. 7, 13-14). FIGS. 15A-15C provide various embodiments of touch pads 900. Touchpads 900 can comprise a plurality of buttons 901 which may be raised above or situated on top of a base 903. Each button of the plurality of buttons 901 may be defined by a border 902. In some embodiments the buttons 901 may not have a border 902, either in a configuration where the buttons 901 are edge to edge, or where the buttons 901 are displayed on a screen having a graphical user interface (GUI). FIG. 15C illustrates placement of touchpad 900 on or in a steering wheel of a marine vessel.

As noted above, the present invention may be embodied in other specific forms without departing from its spirit or essential characteristics. The described embodiments are to be considered in all respects only as illustrative and not restrictive. All changes which come scope.

within the meaning and range of equivalency of the claims are to be embraced within their

1. A thruster system independently operable from a main propulsion system of a marine vessel for providing improved maneuverability of the marine vessel, comprising:
a main power source of the marine vessel;
one or more thruster units mountable at a location on a hull of the marine vessel, each thruster unit comprising:
at least one mounting bracket adapted for direct or indirect attachment to the hull;
an electric motor attached to the at least one mounting bracket; and
a driver attached to and driven by the electric motor;
an electrical control system adapted to control each of the one or more thruster units, the electrical control system comprising electrical circuit components configured to control the electric motor of each of the one or more thruster units, wherein the electrical control system comprises:
one or more electronic speed control units, each electrically coupled to a respective electric motor of the one or more thruster units;
one or more battery packs, each electrically coupled to a respective electronic speed control unit, wherein each battery pack comprises one or more 24-72 volt batteries, and wherein each battery pack outputs a higher discharge current relative to the battery pack's input charging current; and
a control mechanism electrically coupled to the electrical control system, the control mechanism providing operational commands used by the electrical control system to control the electric motor of each of the one or more thruster units.

2. The thruster system of claim 1, wherein the main power source is electrically coupled to the one or more battery packs to enable the main power source to provide power for charging the one or more battery packs.

3. The thruster system of claim 1, wherein the electrical control system comprises:
a DC/DC charger electrically coupled the one or more battery packs, wherein the DC/DC charger is further coupled to the main power source, wherein DC/DC charger converts an input charging current from the main power source to an output charging current, and wherein the output charging current is used to charge the one or more battery packs, and

4. The thruster system of claim 3, the electrical control system further comprising a battery management system electrically coupled to each of the one or more battery packs and configured to limit current from the DC/DC charger in order to trickle charge the one or more battery packs.

5. The thruster system of claim 4, wherein the battery management system is configured to charge the battery pack at a time-dependent charge current and charge voltage calculated based on the chemistry of the battery pack, resulting in the battery pack becoming fully charged without overcharging and damaging the battery pack.

6. The thruster system of claim 3, wherein the DC/DC charger comprises isolated grounds.

7. The thruster system of claim 1, wherein the one or more battery packs receives a charge current and outputs a discharge current at the same time.

8. The thruster system of claim 1, wherein a set of wires are configured to electrically couple the one or more battery packs to a main power source of the marine vessel, and wherein the wires have a smaller gauge than if the one or more battery packs comprised 12-volt batteries.

9. The thruster system of claim 1, wherein the one or more battery packs comprise a lithium-ion battery.

10. The thruster system of claim 1, wherein the thruster system comprises a plurality of thruster units, each independently mountable at a location on a hull of the marine vessel apart from other thruster units mounted to the hull.

11. The thruster system of claim 10, wherein a first thruster unit is mounted at a stern of the hull on a port side of the marine vessel to provide directional thrust at the port side of the stern, a second thruster unit is mounted at the stern of the hull on a starboard side of the marine vessel to provide directional thrust at the starboard side of the stern, and optionally one or more additional thruster units are mounted towards a fore portion of the hull relative to mounting locations of the first and second thruster units.

12. A thruster system independently operable from a main propulsion system of a marine vessel for providing improved maneuverability of the marine vessel, comprising:
a main power source of the marine vessel;
one or more thruster units mountable at a location on a hull of the marine vessel, each thruster unit comprising:
at least one mounting bracket adapted for direct or indirect attachment to the hull;
an electric motor attached to the at least one mounting bracket;
a driver attached to and driven by the electric motor;
an electrical control system adapted to control each of the one or more thruster units, the electrical control system comprising electrical circuit components configured to control the electric motor of each of the one or more thruster units, wherein the electrical control system comprises:
one or more electronic speed control units, each electrically coupled to a respective electric motor of the one or more thruster units;
one or more battery packs, each electrically coupled to a respective electronic speed control unit, wherein each battery pack comprises one or more 24-72 volt batteries; and
a DC/DC charger electrically coupled the one or more battery packs, wherein the DC/DC charger is further coupled to the main power source, wherein the DC/DC charger converts an input charging current from the main power source to an output charging current, and wherein the output charging current is used to charge the one or more battery packs, and
a control mechanism electrically coupled to the electrical control system, the control mechanism providing operational commands used by the electrical control system to control the electric motor of each of the one or more thruster units.

13. The thruster system of claim 12, the electrical control system further comprising a battery management system electrically coupled to each of the one or more battery packs and configured to limit the input charging current from the DC/DC charger in order to trickle charge the one or more battery packs.

14. The thruster system of claim 13, wherein the battery management system is configured to charge the battery pack at a time-dependent charge current and charge voltage calculated based on the chemistry of the battery pack, resulting in the battery pack becoming fully charged without overcharging and damaging the battery pack.

15. The thruster system of claim 13, wherein the battery management system disables power flow from the one or more modular battery packs to the one or more electronic speed control units if the electrical control system is too hot, too cold, or experiences a short circuit.

16. The thruster system of claim 12, wherein each of the one or more battery packs outputs a higher discharge current relative to the input charging current from the main power source.

17. The thruster system of claim 12, the electrical control system further comprising an on/off relay electrically coupled to the main power source to enable or disable power flow from the central charging system to the one or more battery packs.

18. The thruster system of claim 17, wherein the on/off relay enables power flow from the main power source to the DC/DC charger if the voltage is between 11 volts and 16 volts.

19. The thruster system of claim 12, wherein the thruster system comprises a plurality of thruster units, each independently mountable at a location on a hull of the marine vessel apart from other thruster units mounted to the hull.

20. The thruster system of claim 19, wherein a first thruster unit is mounted at a stern of the hull on a port side of the marine vessel to provide directional thrust at the port side of the stern, a second thruster unit is mounted at the stern of the hull on a starboard side of the marine vessel to provide directional thrust at the starboard side of the stern, and optionally a third thruster unit is mounted towards a fore portion of the hull relative to mounting locations of the first and second thruster units.
